(19) United States
(12) Patent Application Publication
(10) Pub. No.: US 2024/0160079 A1
(43) Pub. Date: May 16, 2024

(54) OPTICAL MODULATOR, OPTICAL TRANSMITTER, AND BIASVOLTAGE ADJUSTMENT METHOD OF OPTICAL MODULATOR

(71) Applicant: NEC Corporation, Tokyo (JP)

(72) Inventor: Takanori Shimizu, Tokyo (JP)

(73) Assignee: NEC Corporation, Tokyo (JP)

(21) Appl. No.: 18/384,506

(22) Filed: Oct. 27, 2023

(30) Foreign Application Priority Data
Nov. 10, 2022 (JP) 2022-180613

(51) Int. Cl. G02F 1/21; G02F 1/01

(52) U.S. Cl. CPC G02F 1/212; G02F 1/0123; G02F 1/025

(57) ABSTRACT

An object is to provide an optical modulator capable of adjusting a bias voltage with a simple signal measurement. In a third Mach-Zehnder type optical modulator, a first MZ optical modulator is provided on one arm and a second MZ optical modulator is provided on the other arm. A first photodetector monitors a first output light from the first MZ optical modulator and output a first monitor signal. A second photodetector monitors a second output light from the second MZ optical modulator and output a second monitor signal. A third photodetector monitors a third output light from the third MZ optical modulator and output a third monitor signal. a bias voltage generation unit independently adjusts first to third bias voltages provided to the first to third MZ optical modulators based on the first to third monitor signals, respectively.

### INCORPORATION BY REFERENCE

This application is based upon and claims the benefit of priority from Japanese patent application No. 2022-180613, filed on Nov. 10, 2022, the disclosure of which is incorporated herein in its entirety by reference.

### TECHNICAL FIELD

The present disclosure relates to an optical modulator, an optical transmitter, and a bias voltage adjustment method of optical modulator.

### BACKGROUND ART

To modulate a laser light with a predetermined modulation scheme and transmit the modulated optical signal, various optical modulators have been used. For example, to transmit a quadrature phase shift keying (QPSK) signal, a configuration in which one Mach-Zehnder (MZ) type optical modulator (hereinafter, referred to as a MZ optical modulator) is provided for each of the I-channel (In-phase channel) and Q-channel (Quadrature channel), and an optical signal generated by multiplexing optical signals output from two MZ optical modulators is transmitted has been known (International Patent Publication No. WO 2021/117159 and Japanese Unexamined Patent Application Publication No. 2013-168440).

For example, a configuration in which the intensity of an output light is monitored by connecting a monitoring photodiode to the output of an optical modulator and a bias voltage is feedback-controlled to cause an output deviation due to bias point fluctuation to be reduced has been proposed (International Patent Publication No. WO 2021/117159). In this configuration, a lithium niobate (LiNbO₃, hereinafter, referred to as LN) optical modulator is provided with two MZ optical modulators and an optical signal generated by multiplexing output lights from the two MZ optical modulators is output. Therefore, not only bias voltages respectively provided to the two MZ optical modulators but also a bias voltage for adjusting a phase of one output light before the output lights of the two MZ optical modulators are multiplexed needs to be adjusted. In this configuration, these bias voltages are adjusted based on information detected by only one monitoring photodiode.

Further, a technique in which the variation of a bias point is detected by superimposing a signal for adjusting a bias voltage such as a dither signal on the output light of each MZ optical modulator for adjusting these bias voltages from information of the one monitoring photodiode (Japanese Unexamined Patent Application Publication No. 2013-168440).

### SUMMARY

However, in International Patent Publication No. WO 2021/117159 and Japanese Unexamined Patent Application Publication No. 2013-168440, since a LN optical modulator is used as an optical modulator and a monitoring photodiode needs to be provided outside the LN optical modulator, the entire size increases. Accordingly, if trying to house these components in a package, a size of the package becomes large, and this results in increase in cost.

Further, to superimpose the signal for adjusting the bias voltage such as the dither signal on the output light of each MZ optical modulator, high-performance detectors and measuring instruments, and an advanced waveform signal processing technology are required and this results in further increase in cost.

The present disclosure has been made in view of the circumstances described above, and proposes to provide an optical modulator capable of adjusting a bias voltage with a simple signal measurement.

An aspect of the present disclosure is an optical modulator including: a third Mach-Zehnder type optical modulator in which a first Mach-Zehnder type optical modulator is provided on one of two arms and a second Mach-Zehnder type optical modulator is provided on the other of the two arms; a first photodetector configured to monitor a first output light from the first Mach-Zehnder type optical modulator and output a first monitor signal indicating a monitoring result; a second photodetector configured to monitor a second output light from the second Mach-Zehnder type optical modulator and output a second monitor signal indicating a monitoring result; a third photodetector configured to monitor a third output light from the third Mach-Zehnder type optical modulator and output a third monitor signal indicating a monitoring result; and a bias voltage generation unit configured to independently adjust first to third bias voltages provided to the first to third Mach-Zehnder type optical modulators based on the first to third monitor signals, respectively.

An aspect of the present disclosure is an optical transmitter including: a light source; an optical modulator configured to modulate a light from the light source to output an optical signal; the optical modulator comprising: a third Mach-Zehnder type optical modulator in which a first Mach-Zehnder type optical modulator is provided on one of two arms and a second Mach-Zehnder type optical modulator is provided on the other of the two arms; a first photodetector configured to monitor a first output light from the first Mach-Zehnder type optical modulator and output a first monitor signal indicating a monitoring result; a second photodetector configured to monitor a second output light from the second Mach-Zehnder type optical modulator and output a second monitor signal indicating a monitoring result; a third photodetector configured to monitor a third output light from the third Mach-Zehnder type optical modulator and output a third monitor signal indicating a monitoring result; and a bias voltage generation unit configured to independently adjust first to third bias voltages provided to the first to third Mach-Zehnder type optical modulators based on the first to third monitor signals, respectively.

An aspect of the present disclosure is a bias voltage adjustment method of optical modulator including: in a third Mach-Zehnder type optical modulator in which a first Mach-Zehnder type optical modulator is provided on one of two arms and a second Mach-Zehnder type optical modulator is provided on the other of the two arms, monitoring a first output light from the first Mach-Zehnder type optical modulator and outputting a first monitor signal indicating a monitoring result; monitoring a second output light from the second Mach-Zehnder type optical modulator and outputting a second monitor signal indicating a monitoring result; monitoring a third output light from the third Mach-Zehnder type optical modulator and outputting a third monitor signal indicating a monitoring result; and independently adjusting first to third bias voltages provided to the first to third Mach-Zehnder type optical modulators based on the first to third monitor signals, respectively.

According to the present disclosure, it is possible to provide an optical modulator capable of adjusting a bias voltage with a simple signal measurement.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 schematically illustrates a configuration of an optical transmitter according to a first example embodiment;

FIG. 2 schematically illustrates a configuration of an optical modulator according to the first example embodiment;

FIG. 3 illustrates the configuration of the optical modulator according to a first example embodiment in more detail;

FIG. 4 is a flow chart of a bias voltage adjustment operation of the optical modulator according to the first example embodiment;

FIG. 5 is a flow chart of a modified example of a bias voltage adjustment operation of the optical modulator according to the first example embodiment;

FIG. 6 schematically illustrates a top view of an optical transmitter according to a second example embodiment;

FIG. 7 schematically illustrates a side view of the optical transmitter according to the second example embodiment;

FIG. 8 schematically illustrates a top view of an optical transmitter according to the second example embodiment; and

FIG. 9 schematically illustrates a side view of the optical transmitter according to the second example embodiment.

### EXAMPLE EMBODIMENT

Example embodiments of the present disclosure will be described below with reference to the drawings. In each of the drawings, the same elements will be denoted by the same reference signs, and duplicate description will be omitted as necessary.

### First Example Embodiment

An optical transmitter 1000 according to a first example embodiment will be described. The optical transmitter 1000 transmits an optical signal in response to a control signal and a data signal input from an external communication host such as an optical transmission apparatus. Although the optical signal transmitted by the optical transmitter 1000 is not particularly limited, in the present example embodiment, the optical transmitter 1000 may transmit a QPSK signal or the like, for example. The signal transmitted from the optical transmitter 1000 may be a QAM (Quadrature Amplitude Modulation) signal whose amplitude is multileveled.

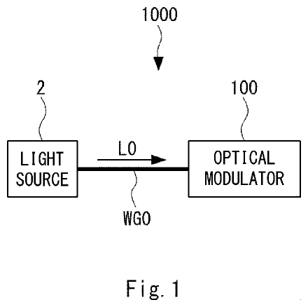

FIG. 1 schematically illustrates a configuration of the optical transmitter 1000 according to the first example embodiment. The optical transmitter 1000 includes an optical modulator 100 and a light source 2. The optical modulator 100 and the light source 2 are connected by an optical waveguide WG0.

The light source 2 is configured, for example, as a wavelength-tunable optical module including a semiconductor optical device and a ring resonator, and outputs a light L0 that is a laser light to the optical modulator 100 through the optical waveguide WG0. The light source 2 is not limited to this, and various light emitting devices and light source modules such as a semiconductor laser outputting a laser light may be used as the light source 2.

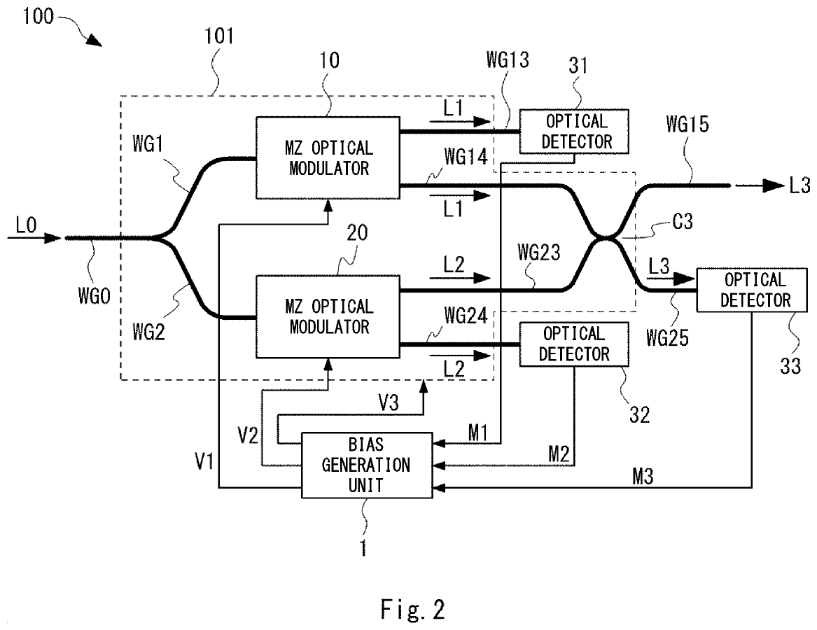

FIG. 2 schematically illustrates a configuration of the optical modulator 100 according to the first example embodiment. The optical modulator 100 includes a MZ optical modulator 101, a bias generation unit 1, and photodetectors 31 to 33. The MZ optical modulator 101 includes two arms. One arm is provided with a MZ optical modulator 10 and the other arm is provided with a MZ optical modulator 20. Hereinafter, the MZ optical modulator 10 is also referred to as a first MZ optical modulator. The MZ optical modulator 20 is also referred to as a second MZ optical modulator. The MZ optical modulator 101 is also referred to as a third MZ optical modulator.

Various optical modulators such as a semiconductor optical modulator and a LN optical modulator formed on a LN substrate may be used as the MZ optical modulator 101.

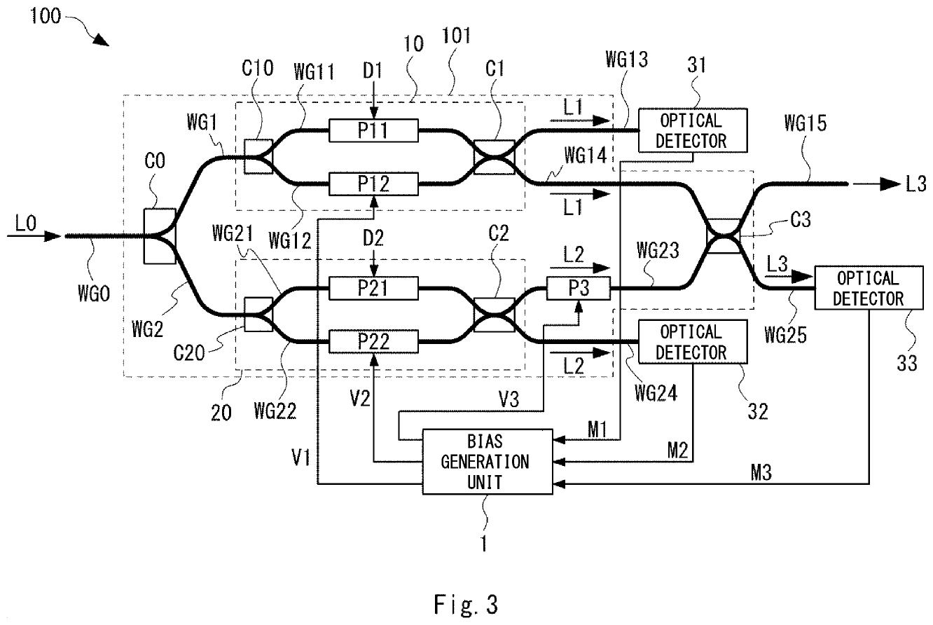

FIG. 3 illustrates the configuration of the optical modulator 100 according to the first example embodiment in more detail. The MZ optical modulator 101 includes the MZ optical modulators 10 and 20, optical couplers C0 to C3, C10, and C20, a phase modulation area P3, and a plurality of optical waveguides. Hereinafter, the optical couplers C1 to C3 are also referred to as first to third optical couplers, respectively.

The bias generation unit 1 applies bias voltages to the MZ optical modulators 10 and 20, and the phase modulation area P3 based on monitor signals M1 to M3 respectively output from the photodetectors 31 to 33. Hereinafter, the photodetectors 31 to 33 are also referred to as first to third photodetectors, respectively. The monitor signals M1 to M3 are also referred to as first to third monitor signals, respectively. Bias voltages V1 to V3 are also referred to as first to third bias voltages, respectively.

The light L0 from the light source 2 propagates through the optical waveguide WG0. Then, the light L0 is branched to optical waveguides WG1 and WG2 by the optical coupler C0 having one input and two outputs.

The MZ optical modulators 10 and 20 are configured as Mach-Zehnder type optical modulators having the same configuration in which data signals are applied to phase modulation areas provided on two arms formed of optical wave guides to output a modulated light that has been modulated with a predetermined modulation scheme.

The phase modulation area is an area provided with an electrode formed on an optical waveguide. When applying an electric signal, for example, a voltage signal to the electrode as a data signal, an effective refractive index of a part under the electrode changes. Thus, since a substantial optical length of the optical waveguide changes, the phase of the light passing through the optical waveguide changes. As a result, since a phase difference between the lights propagating through two optical waveguides is caused, an output light can be modulated. Further, an operating point of the Mach-Zehnder type optical modulator can be adjusted by applying a bias voltage to the phase modulation area.

In the MZ optical modulator 10, the optical coupler C10 having one input and two outputs is provided on the input side, the optical coupler C1 having two inputs and two outputs is provided on the output side, and optical waveguides WG11 and WG12 are connected therebetween in parallel. That is, one output of the optical coupler C10 and one input of the optical coupler C1 are connected by the optical waveguide WG11, and the other output of the optical coupler C10 and the other input of the optical coupler C1 are connected by the optical waveguide WG12. The optical waveguide WG11 is provide with a phase modulation area P11, and the optical waveguide WG12 is provide with a phase modulation area P12.

While various methods for applying a data signal and a bias voltage to an optical modulator may be used, in the present example embodiment, a data signal D1 is applied to the phase modulation area P11, and the bias generation unit 1 applies the bias voltage V1 to the phase modulation area P12. If the optical modulator 100 outputs a QPSK signal as an optical signal L3, the data signal D1 may be, for example, a data signal for modulating an I-channel signal.

One output of the optical coupler C0 and the input of the optical coupler C10 are connected by the optical waveguide WG1. Thus, the light L0 input to the optical coupler C10 is branched to the optical waveguides WG11 and WG12. The light L0 propagating through the optical waveguide WG11 is modulated in response to the data signal D1 applied to the phase modulation area P11, and the modulated light is output to the optical coupler C1. A phase of the light L0 propagating through the optical waveguide WG12 is adjusted in response to the bias voltage V1 applied to the phase modulation area P12, and the adjusted light is output to the optical coupler C1.

The optical coupler C1 multiplexes the lights input from the optical waveguides WG11 and WG12, and branches a modulated light L1 that has been multiplexed to optical waveguides WG13 and WG14. Hereinafter, the modulated light L1 is also referred to as a first output light.

The photodetector 31 is connected to one output of the optical coupler C1 by the optical waveguide WG13, and the modulated light L1 is input to the photodetector 31. Thus, the photodetector 31 outputs the monitor signal M1 indicating a monitoring result of the intensity of the modulated light L1 to the bias generation unit 1.

As described above, the MZ optical modulator 20 has the same configuration as the MZ optical modulator 10. In the MZ optical modulator 20, the optical coupler C20 having one input and two outputs is provide on the input side and the optical coupler C2 having two inputs and two outputs is provide on the output side, and optical waveguides WG21 and WG22 are connected therebetween in parallel. That is, one output of optical coupler C20 and one input of the optical coupler C2 are connected by the optical waveguide WG21, and the other output of optical coupler C20 and the other input of the optical coupler C2 are connected by the optical waveguide WG22. The optical waveguide WG21 is provide with a phase modulation area P21, and the optical waveguide WG22 is provide with a phase modulation area P22.

While various methods for applying a data signal and a bias voltage to an optical modulator may be used, in the present example embodiment, a data signal D2 is applied to the phase modulation area P21, and the bias generation unit 1 applies the bias voltage V2 to the phase modulation area P22. If the optical modulator 100 outputs a QPSK signal as the optical signal L3, the data signal D2 may be, for example, a data signal for modulating a Q-channel signal.

The other output of the optical coupler C0 and the input of the optical coupler C20 are connected by the optical waveguide WG2. Thus, the light L0 input to the optical coupler C20 is branched to the optical waveguides WG21 and WG22. The light L0 propagating through the optical waveguide WG21 is modulated in response to the data signal D2 applied to the phase modulation area P21, and the modulated light is output to the optical coupler C2. A phase of the light L0 propagating through the optical waveguide WG22 is adjusted in response to the bias voltage V2 applied to the phase modulation area P22, and the adjusted light is output to the optical coupler C2.

The optical coupler C2 multiplexes the lights input from the optical waveguides WG21 and WG22, and branches a modulated light L2 that has been multiplexed to optical waveguides WG23 and WG24. Hereinafter, the modulated light L2 is also referred to as a second output light.

The photodetector 32 is connected to one output of the optical coupler C2 by the optical waveguide WG24, and the modulated light L2 is input to the photodetector 32. Thus, the photodetector 32 outputs the monitor signal M2 indicating a monitoring result of the intensity of the modulated light L2 to the bias generation unit 1.

The other input of the optical coupler C1 and one input of the optical coupler C3 having two inputs and two outputs are connected by the optical waveguide WG14. The other input of the optical coupler C2 and the other input of the optical coupler C3 are connected by the optical waveguide WG23. The optical waveguide WG23 is provided with the phase modulation area P3. The bias generation unit 1 applies the bias voltage V3 to the phase modulation area P3. Thus, a phase of the modulated light L2 propagating through the optical waveguide WG23 is adjusted in response to the bias voltage V3 applied to the phase modulation area P3, and the adjusted light is output to the optical coupler C3.

The optical coupler C3 multiplexes the modulated light L1 input from the optical waveguide WG14 and the modulated light L2 input from the optical waveguide WG23, and branches the optical signal L3 that has been multiplexed to optical waveguides WG15 and WG25. The optical signal L3 branched to the optical waveguide WG15 is transmitted to the outside of the optical modulator 100. Hereinafter, the optical signal L3 is also referred to as a third output light.

The photodetector 33 is connected to one output of the optical coupler C3 by the optical waveguide WG25, and the optical signal L3 is input to the photodetector 33. Thus, the photodetector 33 outputs the monitor signal M3 indicating a monitoring result of the intensity of the optical signal L3 to the bias generation unit 1.

The photodetectors 31 to 33 are configured as semiconductor photodetectors, for example. The semiconductor photodetector is configured, for example, as a semiconductor circuit in which an input light is converted into a current signal by a photo diode and the current signal is converted into a voltage signal by a transimpedance amplifier or the like. In this case, the voltage signal to be output corresponds to the monitor signals M1 to M3 described above.

According to the above, the bias generation unit 1 can independently feedback-control the intensity of the modulated light L1 output from the MZ optical modulator 10 by adjusting the bias voltage V1 with reference to the monitor signal M1. Similarly, the bias generation unit 1 can independently feedback-control the intensity of the modulated light L2 output from the MZ optical modulator 20 by adjusting the bias voltage V2 with reference to the monitor signal M2.

Further, the bias generation unit 1 can independently feedback-control the intensity of the optical signal L3 output from the optical coupler C3 by adjusting the bias voltage V3 with reference to the monitor signal M3.

In the present example embodiment, the optical couplers C1 to C3 described above may be configured as a two-input/two-output MMI (Multimode Interferometer) coupler or a directional coupler.

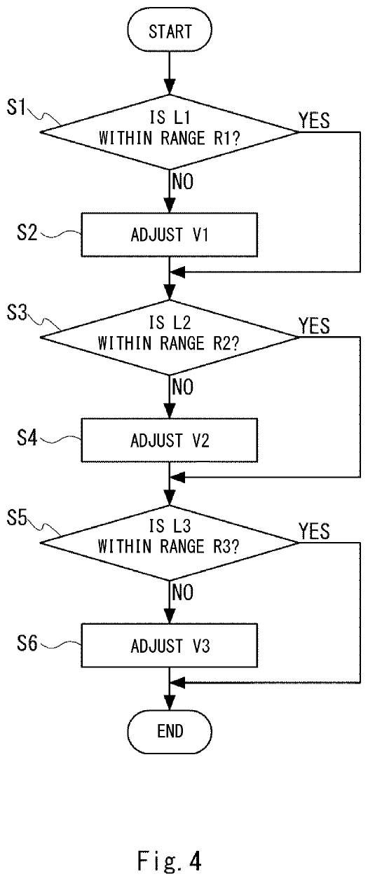

Next, a bias voltage adjustment operation of the optical modulator 100 will be described. FIG. 4 is a flow chart of the bias voltage adjustment operation of the optical modulator 100 according to the first example embodiment.

### Step S1

The bias generation unit 1 monitors whether the intensity of the modulated light L1 falls within a predetermined range R1 using the monitor signal M1.

### Step S2

When the intensity of the modulated light L1 does not fall within the predetermined range R1, the bias generation unit 1 adjusts the bias voltage V1 to cause the intensity of the modulated light L1 to fall within the predetermined range R1. That is, the bias generation unit 1 can independently feedback-control the bias voltage V1 based on the monitoring result of the intensity of the modulated light L1 output from the MZ optical modulator 10.

### Step S3

The bias generation unit 1 monitors whether the intensity of the modulated light L2 falls within a predetermined range R2 using the monitor signal M2.

### Step S4

When the intensity of the modulated light L2 does not fall within the predetermined range R2, the bias generation unit 1 adjusts the bias voltage V2 to cause the intensity of the modulated light L2 to fall within the predetermined range R2. That is, the bias generation unit 1 can independently feedback-control the bias voltage V2 based on the monitoring result of the intensity of the modulated light L2 output from the MZ optical modulator 20.

### Step S5

After confirming that the bias voltages V1 and V2 fall within the predetermined ranges, the bias generation unit 1 monitors whether the intensity of the optical signal L3 falls within a predetermined range R3 using the monitor signal M3.

### Step S6

When the intensity of the optical signal L3 does not fall within the predetermined range R3, the bias generation unit 1 adjusts the bias voltage V3 to cause the intensity of the optical signal L3 to fall within the predetermined range R3. Since the intensities of the modulated lights L1 and L2 have been already adjusted to fall within the predetermined ranges, the bias generation unit 1 can independently feedback-control the bias voltage V3 based on the monitoring result of the intensity of the optical signal L3.

In the case of adjusting the bias voltages V1 and V2, the modulation scheme for modulating the modulated lights L1 and L2 by the data signals D1 and D2 is not limited, and various modulation schemes may be used. Various signals such as a dither signal used for adjusting the bias voltages V1 and V2 may be superimposed on the modulated light L1 and L2. In this case, the bias generation unit 1 can adjust the bias voltages V1 and V2 based on the component of various signals such as a dither signal included in the monitor signal M3, which is generated by the photodetector 33 monitoring the optical signal L3 generated by multiplexing the modulated lights L1 and L2 by the coupler C3 and is output from the photodetector 33. As described above, when the bias generation unit 1 independently controls the bias voltages V1 to V3 based on the monitor signals M1 to M3, respectively, it should be appreciated that various signals such as a dither signal may not be superimposed on the output lights L1 and L2.

As a result, according to the present configuration, the intensities of two MZ optical modulators are independently and respectively adjusted at first. After that, since the intensity of an optical signal generated by multiplexing two modulated lights, the intensity of the optical signal can be independently adjusted apart from adjustment operations of the two modulated lights. That is, according to the present configuration, by separating the adjustment of the two modulated lights and that of the optical signal, the intensities of the two modulated lights and the optical signal can be independently and easily adjusted, respectively.

This adjustment operation is advantageous in that it can be easily performed only by monitoring the intensity of the light without superimposing various signals such as a dither signal and without complicated signal processing. Further, it should be appreciated that this adjustment operation can be performed even if various signals such as a dither signal are superimposed.

In the present configuration, if the adjustments of the modulated light L1 and L2 has been completed prior to the adjustment of the optical signal L3, the order of the steps S1 and S2 according to the modulated light L1 and the steps S3 and S4 according to the modulated light L2 may be reversed. That is, the steps S3 and S4 may be performed after the steps S1 and S2 has been completed, and the steps S1 and S2 may be performed after the steps S3 and S4 has been completed.

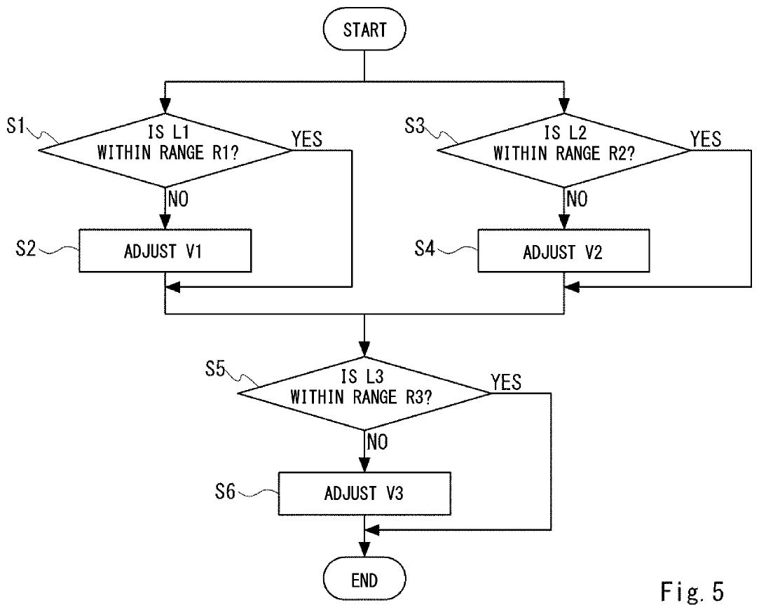

Further, the steps S1 and S2 according to the modulated light L1 and the steps S3 and S4 according to the modulated light L2 may be performed in parallel. FIG. 5 is a flow chart of a modified example of a bias voltage adjustment operation of the optical modulator 100 according to the first example embodiment. Even in FIG. 5, since the adjustments of the modulated lights L1 and L2 can be completed prior to the adjustment of the optical signal L3, the intensities of the two modulated lights and the optical signal can be independently and easily adjusted, respectively.

### Second Example Embodiment

An optical transmitter according to a second example embodiment will be described. In an optical transmitter, an optical modulator can be configured, for example, as a LN optical modulator. However, in this case, it is difficult to integrate the optical modulator on the same substrate with a photodetector and a light source configured as semiconductor devices. In other word, it is difficult to form the LN optical modulator on the same substrate with the semiconductor device such as a photodetector and a light source by the same process due to the difference of substrate materials in principle. Therefore, it is necessary to form the semiconductor device such as a photodetector and a light source separately from the LN optical modulator and to combine these devices in the latter process.

Further, since these devices cannot be integrated on the same substrate, the layout thereof is limited, and thereby it is disadvantageous in that the size of the optical transmitter increases. In contrast to this, miniaturization of the optical transmitter has been desired due to the demand for miniaturization of an optical module and for achieving the implementation of necessary components including the optical transmitter in a case of the optical module that is limited by the standard.

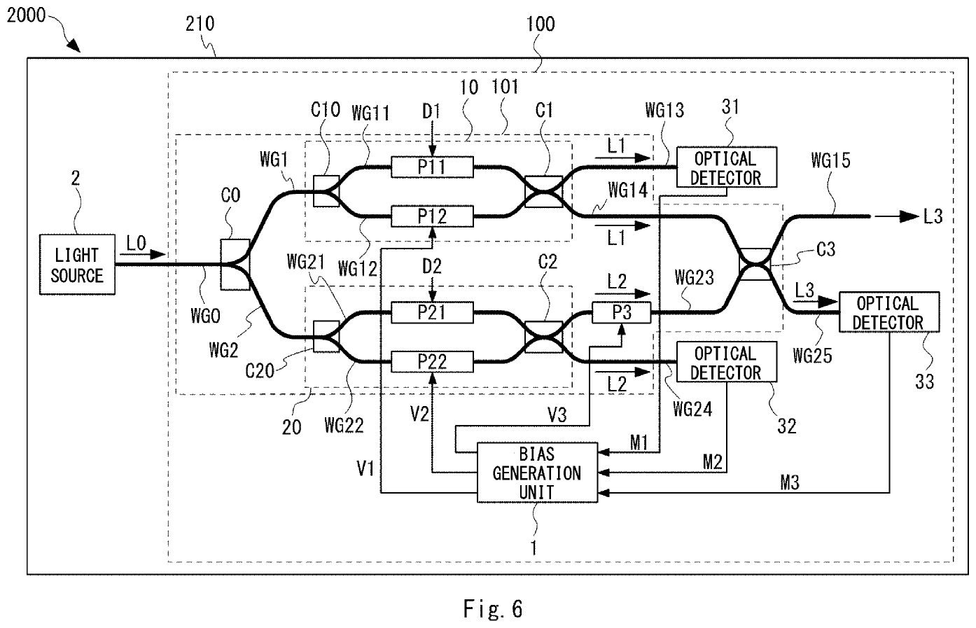

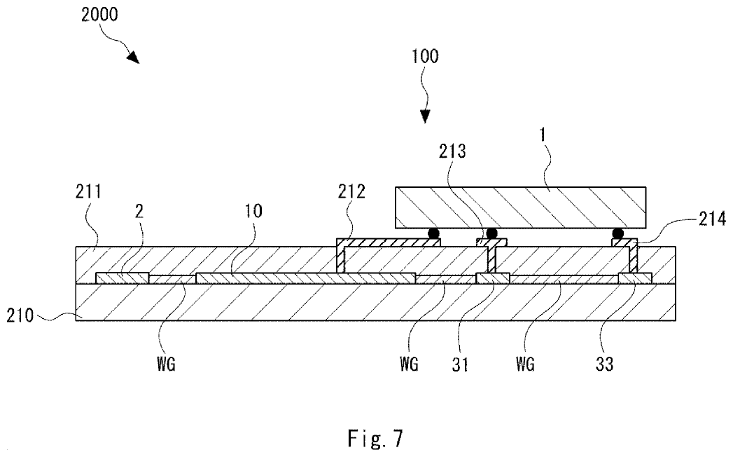

Meanwhile, a semiconductor optical modulator including optical waveguides formed of semiconductor materials such as silicon and indium phosphide (InP) can be also used as the optical modulator. In this case, the optical modulator, the photodetector, and the light source can be easily formed on the same substrate of semiconductor material by the same process. FIG. 6 schematically illustrates a top view of an optical transmitter 2000 according to the second example embodiment. FIG. 7 schematically illustrates a side view of the optical transmitter 2000 according to the second example embodiment. In the optical transmitter 2000, the optical modulator 100 and the light source 2 is formed on a semiconductor substrate 210.

The bias generation unit 1 is mounted on a passivation member 211 covering the semiconductor substrate 210. The passivation member 211 is configured, for example, as a waveguide clad with respect to a waveguide core. The bias generation unit 1 is connected to the MZ optical modulators 10 and 20, and the photodetectors 31 to 33 by via connections. In FIG. 7, for simplification, a via connection connecting between the bias generation unit 1 and the MZ optical modulator 10 is denoted by a numerical sign 212, and via connections connecting between the bias generation unit 1 and the photodetectors 31 and 33 are denoted by numerical signs 213 and 214, respectively.

FIG. 7 is the schematic side view of the optical transmitter 2000 and, for simplification, the representation of the MZ optical modulator 20 and the photodetector 32 are omitted, and each optical waveguide is denoted by a sign WG. Although not illustrated in FIG. 7, it should be appreciated that the MZ optical modulator 20 and the photodetector 32 are also connected to the bias generation unit 1 by via connections.

According to the present configuration, since the flexibility of the layout of the optical modulator, the photodetector, and the light source is increased, these devices can be integrated more densely as compared to the LN optical modulator. Accordingly, the optical transmitter can be miniaturized.

Further, since the MZ optical modulator, the photodetector, and the light source can be concurrently fabricated by the same process, the fabrication time of the optical transmitter can be reduced as compared to the case using LN optical modulator. Although the present configuration is configured by adding three photodetectors to the optical modulator, the present configuration can be achieved without prominent increase in cost as compared to the case of not forming the photodetectors since the light source, the MZ optical modulators, and the photodetectors can be concurrently formed by the same semiconductor process.

Further, as described above, the reduction of manufacturing cost can be also achieved due to the miniaturization of an optical transmitter and the reduction of manufacturing time.

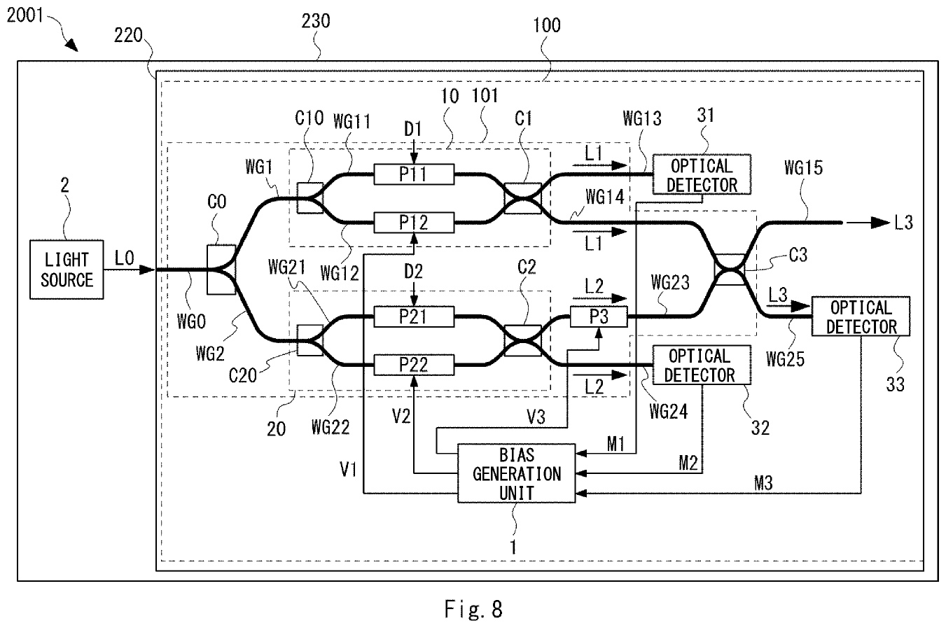

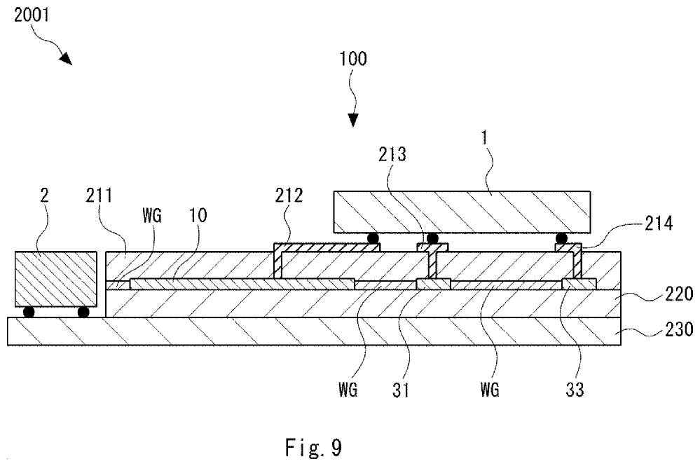

Note that it is conceivable that there may be a need to separate the light source 2 and the optical modulator 100, and to flexibly combine a desired light source and optical modulator depending on the use. In this case, the light source 2 can be selected according to a used wavelength, and it is possible to manufacture the optical transmitter having a configuration in which the selected light source 2 (formed on the InP substrate) is mounted on the same substrate (e.g., silicon substrate) as the optical modulator 100 or a configuration in which the selected light source 2 and the optical modulator 100 are mounted on a carrier substrate. The configuration in which the selected light source 2 (formed on the InP substrate) is mounted on the same substrate (e.g., silicon substrate) as the optical modulator 100 will be described. FIG. 8 schematically illustrates a top view of an optical transmitter 2001 according to the second example embodiment. FIG. 9 schematically illustrates a side view of the optical transmitter 2001 according to the second example embodiment. In this configuration, a silicon oxide layer 220 and a passivation member 211 are stacked on a silicon substrate 230, and the optical transmitter and the photodetector other than the light source 2 are manufactured on the silicon oxide layer 220. Then, a part on which the light source 2 is to be mounted is formed by etching, a semiconductor laser chip is mounted on the formed part as the light source 2, and the light source 2 is optically connected to an optical waveguide. According to the present configuration, since the MZ optical modulator and the photodetector can be concurrently manufactured by the same process and the light source can be mounted on the same substrate as the MZ optical modulator and the photodetector, the flexibility of the layout of the MZ optical modulator, the photodetector, or the like in the optical modulator 100 is increased. Therefore, these devices can be integrated more densely as compared to the LN optical modulator.

Next, the configuration in which the selected light source 2 and the optical modulator 100 are mounted on a carrier substrate will be described. In this configuration, as compared to the configuration in which the selected light source 2 (formed on the InP substrate) is mounted on the same substrate (e.g., silicon substrate) as the optical modulator 100 described above, the silicon substrate 230 is replaced with a carrier substrate 230, and the silicon oxide layer 220 is replaced with a semiconductor substrate 220. The optical modulator 100 is formed on the single semiconductor substrate 220. Needless to say, the light source 2 and the optical waveguide WG0 of the optical modulator 100 are aligned to be able to transmit the light L0. Since the other configuration of the optical transmitter 2001 is similar to that of the optical transmitter 2000, the redundant description thereof will be omitted.

According to the present configuration, although the light source cannot be integrated with the optical modulator on the same semiconductor substrate, the flexibility of the layout of the MZ optical modulator and the photodetector in the optical modulator 100 increases since these components can be more densely as compared to the LN optical modulator. Accordingly, the optical transmitter can be miniaturized.

Further, the manufacturing cost can be also reduced by miniaturizing the optical transmitter and reducing the manufacturing time.

### Other Example Embodiments

Note that the present disclosure is not limited to the example embodiment described above, and may be appropriately modified without departing from the scope of the present disclosure. For example, the above-described optical modulator is not only used alone, but also a plurality of the optical modulators may be arranged in parallel or cascaded. In this case, three bias voltages can be independently controlled in each optical modulator as described above.

The above-described semiconductor device and semiconductor substrate is not limited to those formed of specific semiconductor material, and any semiconductor material such as silicon and InP can be used. Although the photodetector has been described as including the photodiode and the transimpedance amplifier, it is merely an example. As long as the light can be detected, the photodetector may be of any configurations.

Application of the data signals and the bias voltages to the MZ optical modulators 10 and 20 is not limited to the above-described example embodiments, and the MZ optical modulators 10 and 20 may be of other configurations. For example, as in International Patent Publication No. WO 2021/117159, the phase adjustment areas of the MZ optical modulators 10 and 20 may be configured in such a manner that one of two electrodes is for the data signal and the other of the two electrodes is for the bias voltage in each arm, and differential data signals may be allied to a pair of the electrodes for the data signals respectively provided on the arms.

Although the phase modulation area P3 has been described as being provided on the optical waveguide WG23, it is merely an example. For example, the phase modulation area P3 may be provided on the optical waveguide WG14, and may be appropriately provided at other positions as long as the bias voltage can be applied to the MZ optical modulator 101. While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An optical modulator comprising:
a third Mach-Zehnder type optical modulator in which a first Mach-Zehnder type optical modulator is provided on one of two arms and a second Mach-Zehnder type optical modulator is provided on the other of the two arms;
a first photodetector configured to monitor a first output light from the first Mach-Zehnder type optical modulator and output a first monitor signal indicating a monitoring result;
a second photodetector configured to monitor a second output light from the second Mach-Zehnder type optical modulator and output a second monitor signal indicating a monitoring result;
a third photodetector configured to monitor a third output light from the third Mach-Zehnder type optical modulator and output a third monitor signal indicating a monitoring result; and
a bias voltage generation unit configured to independently adjust first to third bias voltages provided to the first to third Mach-Zehnder type optical modulators based on the first to third monitor signals, respectively.

2. The optical modulator according to claim 1, wherein the bias voltage generation unit adjusts the third bias voltage after adjusting the first and second bias voltages.

3. The optical modulator according to claim 1, wherein the optical modulator and the photodetectors are configured as semiconductor devices formed on the same semiconductor substrate.

4. The optical modulator according to claim 3, wherein a light source outputting a light to the third Mach-Zehnder type optical modulator is configured as a semiconductor device and formed on the same substrate as the optical modulator and the photodetectors.

5. The optical modulator according to claim 1, further comprising first to third couplers respectively provided at output ends of the first to third Mach-Zehnder type optical modulators, each of the first to third couplers having two inputs and two outputs, wherein
the first photodetector detects the first output light from one output of the first coupler,
the second photodetector detects the second output light from one output of the second coupler,
the third photodetector detects the third output light from one output of the third coupler,
the other output of the first coupler is connected to one input of the third coupler, and the other output of the second coupler is connected to the other input of the third coupler, and
an output light of the optical modulator is output from the other output of the third coupler.

6. The optical modulator according to claim 1, wherein
the first to third photodetectors respectively monitor the first to third Mach-Zehnder type optical modulators, and each of the first to third photodetectors does not output a signal including a monitoring result of another Mach-Zehnder type optical modulator.

7. The optical modulator according to claim 1, wherein the first and second output lights does not include a signal that the third photodetector detects to adjust the first and second bias voltages provided to the first and second Mach-Zehnder type optical modulators after the first and second output lights are multiplexed and thereby converted into the third output light.

8. An optical transmitter comprising:
a light source;
an optical modulator configured to modulate a light from the light source to output an optical signal;
the optical modulator comprising:
a third Mach-Zehnder type optical modulator in which a first Mach-Zehnder type optical modulator is provided on one of two arms and a second Mach-Zehnder type optical modulator is provided on the other of the two arms;
a first photodetector configured to monitor a first output light from the first Mach-Zehnder type optical modulator and output a first monitor signal indicating a monitoring result;
a second photodetector configured to monitor a second output light from the second Mach-Zehnder type optical modulator and output a second monitor signal indicating a monitoring result;
a third photodetector configured to monitor a third output light from the third Mach-Zehnder type optical modulator and output a third monitor signal indicating a monitoring result; and
a bias voltage generation unit configured to independently adjust first to third bias voltages provided to the first to third Mach-Zehnder type optical modulators based on the first to third monitor signals, respectively.

9. A bias voltage adjustment method of optical modulator comprising:
in a third Mach-Zehnder type optical modulator in which a first Mach-Zehnder type optical modulator is provided on one of two arms and a second Mach-Zehnder type optical modulator is provided on the other of the two arms,
monitoring a first output light from the first Mach-Zehnder type optical modulator and outputting a first monitor signal indicating a monitoring result;
monitoring a second output light from the second Mach-Zehnder type optical modulator and outputting a second monitor signal indicating a monitoring result;
monitoring a third output light from the third Mach-Zehnder type optical modulator and outputting a third monitor signal indicating a monitoring result; and
independently adjusting first to third bias voltages provided to the first to third Mach-Zehnder type optical modulators based on the first to third monitor signals, respectively.
